(19) United States
(12) Patent Application Publication
(10) Pub. No.: US 2024/0167504 A1
(43) Pub. Date: May 23, 2024

(54) ROTATING EQUIPMENT MONITORING DEVICE AND A METHOD FOR OPERATING A ROTATING EQUIPMENT MONITORING DEVICE

(71) Applicant: Aktiebolaget SKF, Göteborg (SE)

(72) Inventors: Renxiang CHEN, Shanghai (CN); Zhichao HONG, Shanghai (CN)

(21) Appl. No.: 18/505,517

(22) Filed: Nov. 9, 2023

(30) Foreign Application Priority Data
Nov. 18, 2022 (CN) 202211448836.9

(51) Int. Cl. F16C 19/52; F16C 33/72; F16C 41/00

(52) U.S. Cl. CPC F16C 19/52; F16C 33/726; F16C 41/008; F16C 2233/00

(57) ABSTRACT

The present disclosure relates to a rotating equipment monitoring device and a method for operating a rotating equipment monitoring device. The rotating equipment monitoring device includes a housing having a first accommodating space and a second accommodating space. The second accommodating space is located at an end of the housing and separated from the first accommodating space by a partition wall of the housing. A sensor assembly is arranged in the first accommodating space. An antenna circuit board has an antenna installed thereon. The antenna communicates with the sensor assembly and is arranged in the second accommodating space. A cover seals the antenna circuit board in the second accommodating space. The first accommodating space is filled with an explosion-proof medium that completely surrounds the sensor assembly.

### CROSS-REFERENCE TO RELATED APPLICATION

This application claims priority to Chinese Application No. 202211448836.9, filed Nov. 18, 2022, the entirety of which is hereby incorporated by reference.

### FIELD

The present disclosure relates to a rotating equipment monitoring device and method for operating a rotating equipment monitoring device.

### BACKGROUND

Bearings are important components in mechanical equipment, mainly used to support rotating machinery, reduce friction coefficient during its movement, and ensure its rotational accuracy. Monitoring the health status of bearings in industrial equipment is an important means to ensure the normal operation of industrial equipment. Generally, rotating equipment monitoring devices, especially bearing monitoring devices, can be used to measure the speed, acceleration, temperature, vibration, etc. of bearings, and the signals obtained from the measurement will be transmitted to digital cloud platforms for analysis and diagnosis. If there is an abnormal diagnostic alarm, the customer is notified for repair or maintenance.

In some known schemes, the rotating equipment monitoring device can transmit signals through wired means, which makes the installation of rotating equipment monitoring devices more difficult and brings inconvenience to industrial equipment. In other known schemes, the rotating equipment monitoring device can use Bluetooth with low power consumption for signal transmission, but such schemes require the installation of additional gateways or routers to upload data to the cloud, which is not conducive to installation and cost control. In yet other known schemes, the rotating equipment monitoring device can use RFID technology to achieve short-range wireless transmission, but such schemes transmit less data and cannot support the required amount of data for fault diagnosis, and cannot be used for long-distance communication, making it impossible to remotely monitor equipment conditions.

There are various factors that affect antenna performance, especially transmission efficiency, in the rotating equipment monitoring device, such as metals and conductors in circuit boards, an explosion-proof medium such as AB adhesive, antenna clearance position and so on. Especially, the explosion-proof medium used to meet the Nc sealing explosion-proof certification requirements of the rotating equipment monitoring device has a significant impact on the transmission efficiency. The above various factors lead to the problem that the rotating equipment monitoring device using wireless remote communication technology cannot meet both transmission efficiency and Nc sealing explosion-proof certification requirements. To meet the transmission efficiency requirements, it is necessary to ensure that the antenna is not wrapped by the explosion-proof medium, such as AB adhesive, and maintains enough clearance from the PCBA motherboard of the sensor, so the antenna is usually arranged at the top. However, the scheme of arranging the antenna at the top usually cannot meet the explosion-proof certification requirements.

### SUMMARY

Therefore, the object of the present disclosure is to provide a rotating equipment monitoring device and a method for operating a rotating equipment monitoring device. The rotating equipment monitoring device has an antenna which is not encapsulated by an explosion-proof medium and is located in a space separated from a sensor assembly and related circuits, thus having high transmission efficiency and meeting requirements of Nc sealing explosion-proof level. The rotating equipment monitoring device also adopts narrowband wireless communication technology, thus achieving long-distance wireless transmission without gateway. In addition, the rotating equipment monitoring device has high monitoring sensitivity, good waterproof and temperature resistance performance, and therefore higher reliability. Furthermore, the method of operating the rotating equipment monitoring device utilizes a combination of Near Field Communication (NFC) and Bluetooth communication technology with narrowband wireless communication technology.

The above object is achieved by the rotating equipment monitoring device and the method for operating the rotating equipment monitoring device described below.

The present disclosure provides a rotating equipment monitoring device comprising: a housing comprising a first accommodating space and a second accommodating space, wherein the second accommodating space is located at an end of the housing and separated from the first accommodating space by a partition wall of the housing; a sensor assembly arranged in the first accommodating space; an antenna circuit board with an antenna installed thereon, wherein the antenna is configured to communicate with the sensor assembly and is arranged in the second accommodating space; and a cover sealing the antenna circuit board in the second accommodating space, wherein the first accommodating space is filled with an explosion-proof medium that completely surrounds the sensor assembly.

In an embodiment, the rotating equipment monitoring device further comprises an adhesive part, which adheres the antenna circuit board to the partition wall of the housing.

In an embodiment, the housing comprises a stepped protrusion at an inner wall at its end, and the protrusion extends along the circumference of the inner wall.

In an embodiment, the rotating equipment monitoring device further comprises a sealant, which is filled between the cover and the protrusion along the circumference of the antenna circuit board.

In an embodiment, the antenna circuit board is arranged at a certain distance from an innermost wall of the protrusion to form a first gap for accommodating the sealant in a transverse direction.

In an embodiment, the adhesive part is arranged at a certain distance from a circumferential edge of the antenna circuit board to form a second gap for accommodating the sealant in a transverse direction.

In an embodiment, a first opening is provided on the antenna circuit board, and a second opening at least partially aligned with the first opening is provided on the partition wall of the housing, wherein the explosion-proof medium is filled into the first accommodating space through the first opening and the second opening.

In an embodiment, a first exhaust opening is also provided on the antenna circuit board, and a second exhaust opening at least partially aligned with the first exhaust opening is provided on the partition wall of the housing.

In an embodiment, the rotating equipment monitoring device further comprises a first circuit board and a second circuit board arranged in the first accommodating space and spaced apart from each other, wherein the sensor assembly is arranged on the first circuit board, and a near-field communication module and a Bluetooth module are arranged on the second circuit board.

In an embodiment, the antenna is an NB-IOT antenna, and other NB-IOT module assemblies that cooperate with the NB-IOT antenna and a radio frequency interface for connecting with the antenna are also provided on the first circuit board.

In an embodiment, the rotating equipment monitoring device further comprises a power assembly arranged between the first circuit board and the second circuit board.

In an embodiment, the second circuit board is arranged adjacent to an inner surface of a flat sidewall of the housing.

In an embodiment, the housing comprises a metal base, and the first circuit board and the second circuit board are respectively fixed to the metal base through threaded fasteners.

In an embodiment, an indicator light and a light guide member are arranged at the top of the first circuit board near the partition wall of the housing, and the light emitted by the indicator light is emitted towards the outside of the top of the housing through the guidance of the light guide member.

In an embodiment, a first hole is provided on the antenna circuit board, a second hole aligned with the first hole is provided on the partition wall of the housing, and the light guide member passes through the first hole and the second hole.

The present disclosure further provides a method for operating a rotating equipment monitoring device, and the method is performed with the rotating equipment monitoring device as mentioned above and comprises the following steps: bringing a mobile communication device close to the flat sidewall of the housing of the rotating equipment monitoring device; activating the sensor assembly through a communication connection between a near-field communication module of the mobile communication device and the near-field communication module of the rotating equipment monitoring device; and setting the sensor assembly through a communication connection between a Bluetooth module of the mobile communication device and the Bluetooth module of the rotating equipment monitoring device.

In an embodiment, the method further comprises the following step: the sensor assembly uploads the collected data to a cloud through the antenna.

The beneficial effects of the present disclosure are described below.

In the rotating equipment monitoring device mentioned above, the antenna is not encapsulated by the explosion-proof medium and is located in a space separated from the sensor assembly and related circuits. Therefore, the rotating equipment monitoring device has high transmission efficiency and can meet the requirements of Nc sealing explosion-proof level. In addition, the explosion-proof medium is used to encapsulate the sensor assembly such that the rotating equipment monitoring device has high monitoring sensitivity and good temperature resistance performance. The use of the sealant and the gaps mentioned above enables the rotating equipment monitoring device to have improved waterproof performance and thus high reliability.

Specifically, the rotating equipment monitoring device of the present disclosure can achieve an average transmission efficiency as high as more than 30%, which can meet the requirements of sufficiently long transmission coverage and reduce communication power consumption, thereby extending the service life of the sensor. Based on the above transmission efficiency, the rotating equipment monitoring device of the present disclosure can use narrowband wireless communication technology, such as Narrow Band Internet of Things (NB-IOT), to achieve long-distance wireless transmission, thereby achieving the function of long-distance communication and uploading data to the cloud, without relying on a gateway.

Furthermore, the rotating equipment monitoring device with a 2-zone explosion-proof rating of the present disclosure can be used in areas with gas explosion hazards and areas with dust explosion hazards, meeting the explosion-proof requirements of customers.

In addition, the method for operating the rotating equipment monitoring device of the present disclosure utilizes a combination of NFC and Bluetooth communication technologies with narrowband wireless communication technology, which not only facilitates the activation of the rotating equipment monitoring device, but also allows for flexible setting of various parameters of the rotating equipment monitoring device.

### BRIEF DESCRIPTION OF THE DRAWINGS

In order to clarify the technical solutions of embodiments of the present disclosure more clearly, the accompanying drawings of the embodiments of the present disclosure will be briefly introduced in the following text. Among them, the accompanying drawings are only used to illustrate some embodiments of the present disclosure, rather than limiting all embodiments of the present disclosure to this. In the drawings:

FIG. 1 schematically illustrates a schematic diagram of a known bearing monitoring device;

FIG. 2 schematically illustrates a schematic diagram of a rotating equipment monitoring device according to an embodiment of the present disclosure;

FIG. 3 schematically illustrates a part of a rotating equipment monitoring device according to an embodiment of the present disclosure;

FIG. 4 schematically illustrates an enlarged schematic diagram of a part of the rotating equipment monitoring device according to an embodiment of the present disclosure;

FIG. 5 schematically illustrates a schematic diagram of an antenna circuit board on which an antenna is installed and an adhesive part of the rotating equipment monitoring device according to an embodiment of the present disclosure;

FIG. 6 illustrates an external schematic diagram of a rotating equipment monitoring device according to an embodiment of the present disclosure; and

FIG. 7 illustrates an inner schematic diagram of a rotating equipment monitoring device according to an embodiment of the present disclosure.

### DETAILED DESCRIPTION

In order to make the objects of technical solutions, technical solutions, and advantages of the present disclosure clearer, the following will provide a clear and complete description of the technical solutions of embodiments of the present disclosure in conjunction with the accompanying drawings of the specific embodiments. The same reference signs in the accompanying drawings represent the same components. It should be noted that the described embodiments are a portion of the embodiments of the present disclosure, rather than all of them. Based on the described embodiments of the present disclosure, all other embodiments obtained by one of ordinary skill in the art without the need for creative labor fall within the scope of protection of the present disclosure.

Unless otherwise defined, the technical or scientific terms used herein shall have the usual meaning understood by one of ordinary skill in the art to which this disclosure belongs. The use of “first”, “second”, and similar terms in the specification and claims of this patent application does not indicate any order, quantity, or importance, but is only used to distinguish different components. Similarly, similar words such as “one”, “a” or “an” do not necessarily indicate quantitative limitations. Words such as “including”, “comprising”, or “having” means that the components or objects that appear before the words, include the components or objects listed after the words and their equivalents, without excluding other components or objects. Words such as “connecting” or “coupling” are not limited to the physical or mechanical connections or couplings shown in the drawings, but can include their equivalent connections or couplings, whether direct or indirect. The terms “up”, “down”, “left”, “right”, etc. are only used to represent relative positional relationships. When the absolute position of the described object changes, the relative positional relationship may also change accordingly.

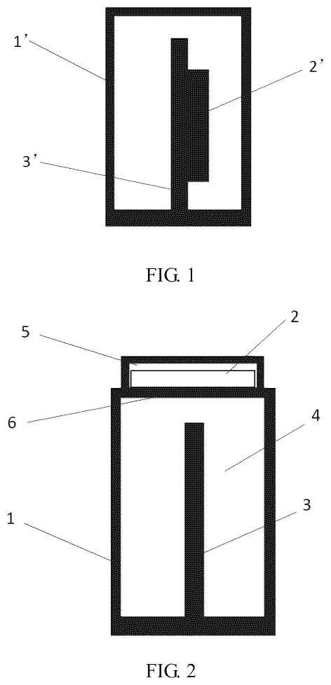

The following describes in detail the various implementations of the rotating equipment monitoring device according to the embodiments of the present disclosure with reference to FIGS. 1-7.

FIG. 1 shows a known bearing monitoring device, which comprises a housing 1′, an antenna 2′ located within the housing 1′, and a sensor assembly 3′. In addition, the housing 1′ is filled with an explosion-proof medium, such as AB adhesive, to completely encapsulate the antenna 2′ and the sensor assembly 3′. The sensor assembly 3′ comprises various sensors and a main circuit board on which the sensors are installed, and is therefore schematically shown as a board. The antenna 2′ can also be installed on the main circuit board. In the bearing monitoring device shown in FIG. 1, due to the impact of the explosion-proof medium on the antenna 2′, its transmission efficiency is relatively low. In addition, the antenna 2′ in the bearing monitoring device shown in FIG. 1 is arranged parallel to the main circuit board and is close to the main circuit board, which further affects the transmission efficiency. Therefore, the bearing monitoring device in FIG. 1 cannot be used for long-distance wireless transmission.

FIG. 2 shows a highly schematic diagram of an embodiment of a rotating equipment monitoring device according to the present disclosure, and the specific structure of the rotating equipment monitoring device may differ from that shown in FIG. 2. As shown in FIG. 2, the rotating equipment monitoring device comprises a housing 1, an antenna circuit board 2 with an antenna installed thereon, and a sensor assembly 3. The antenna is an NB-IOT antenna, which enables long-distance signal transmission with low-power consumption. The rotating equipment monitoring device of the present disclosure can particularly be a bearing monitoring device for measuring the speed, acceleration, temperature, vibration, etc. of bearings. Of course, the present disclosure is not limited to measuring bearings, but can also be used to measure parameters of other rotating equipment.

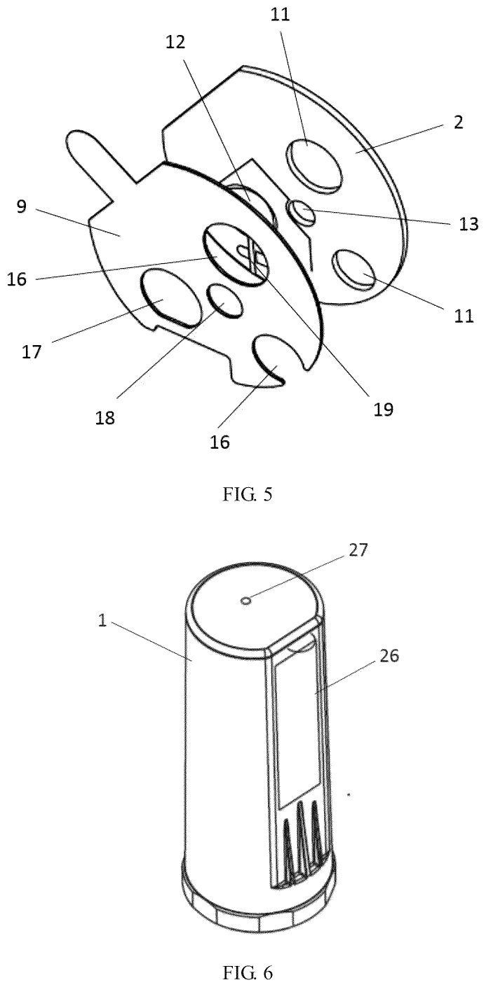

The housing 1 comprises a first accommodating space 4 and a second accommodating space 5 which is located at an end of the housing 1 and separated from the first accommodating space 4 by a partition wall 6of the housing 1. For example, the housing 1 can be mostly made of plastic and can have a metal base. The housing 1 can have a roughly cylindrical shape, while the antenna circuit board 2 can have a shape that matches the circular cross-section of the housing 1, such as a roughly circular plate shaped component, as shown in FIG. 5, and can have a thickness of approximately 1 mm.

The sensor assembly 3 is arranged in the first accommodating space 4, which is filled with the explosion-proof medium that completely surrounds the sensor assembly 3. The explosion-proof medium can prevent explosions caused by the reaction of electric arcs and sparks that may be produced during the operation of the rotating equipment monitoring device with external gases. The explosion-proof medium can be an AB adhesive, such as a castable two-component casting resin based on polyurethane, which is composed of filling component A and isocyanate hardener B (MDI). The sensor assembly 3 can be arranged on or as part of the main circuit board, i.e. PCBA board, for example. The main circuit board comprises but is not limited to temperature and gravity acceleration sensor chips, battery and power management devices for sensor system, and various electronic components. The sensor assembly 3 can include sensor chips for sensing the speed, acceleration, temperature, etc. of the bearing to be monitored. For example, the above sensors can be piezoelectric or MEMS sensors. The signal sensed by the sensor can be processed and calculated by a microcontroller MCU after passing through the signal processing circuit (such as amplifier, filter) on the PCBA board, and then transmitted to a remote control device in the cloud by the NB-IOT module through the antenna. The sensed data can be transmitted to the cloud through the NB-IOT antenna, and then fault diagnosis can be performed on the data stored in the cloud before notifying the user to maintain the device. For example, the data can include signals representing temperature or vibration data, as well as alarm signals representing temperature or vibration.

As shown in FIG. 2, the antenna circuit board 2 or antenna is arranged substantially perpendicular to the sensor assembly 3, which further avoids the impact on the transmission rate caused by the antenna arranged parallel to the main circuit board.

In order to achieve signal transmission with sensor assembly 3, the antenna installed on antenna circuit board 2 is configured to communicate with the sensor assembly 3, such as with RF wired connection, and is located in the second accommodating space 5. Specifically, the sensor assembly 3 or main circuit board located in the first accommodating space 4 can be electrically connected to the antenna located in the second accommodating space 5 through cables.

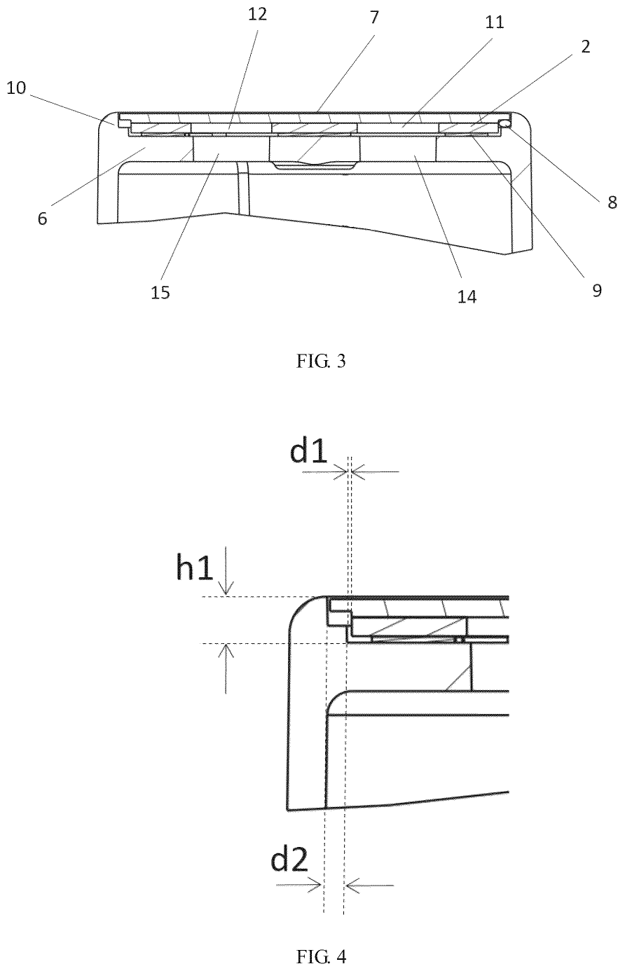

As shown in FIG. 3, the rotating equipment monitoring device further comprises a cover 7, which seals the antenna circuit board 2 in the second accommodating space 5. The cover 7 can be a transparent plastic cover, such as a plastic sheet or plate made of PC or PET material. By using the plastic cover to encapsulate the antenna, the additional impact of external structures (such as the cover) on antenna transmission efficiency can be reduced. Of course, the cover 7 can also be made of opaque material, which meets the IP69K, explosion-proof sealing requirements, and the appearance is consistent with the housing, for example, the two have the same color. Therefore, the cover also has a decorative effect, making the rotating equipment monitoring device of the present disclosure more aesthetically pleasing.

In one embodiment, the rotating equipment monitoring device further comprises an adhesive part 9, which adheres the antenna circuit board 2 to the partition wall 6 of the housing 1. The partition wall 6 can be a top wall of housing 1. The adhesive part 9 can be double-sided adhesive tape or formed by adhesive. When the double-sided adhesive tape is used as the adhesive part 9, it can be cut according to the specific form of the antenna circuit board 2 and the housing 1. In addition, the rotating equipment monitoring device can also comprises a further adhesive part for adhering the cover 7 to the antenna circuit board 2.

In addition, the housing 1 comprises a stepped protrusion 10 at an inner wall at its end, and the protrusion extends along the circumference of the inner wall. The protrusion 10 forms the second accommodating space 5 with the partition wall 6, and the cover 7 closes the second accommodating space 5. For example, the protrusion 10 can be integrally formed with the housing 1. Of course, the protrusion 10 can also be a separate component.

As shown in FIG. 3, the rotating equipment monitoring device further comprises a sealant 8, which is filled between the cover 7 and the protrusion 10 along the circumference of the antenna circuit board 2. FIG. 3 only schematically shows the sealant 8 on one side of the antenna circuit board 2. Specifically, most of the sealant 8 is filled between the steps of the protrusion 10 and the cover 7. In this way, good sealing of the rotating equipment monitoring device can be achieved. For example, the sealant 8 is a waterproof adhesive, which makes the rotating equipment monitoring device of the present disclosure also have improved waterproof performance.

As shown in the enlarged diagram of FIG. 4, the antenna circuit board 2 is arranged at a certain distance from an innermost wall of the protrusion 10, as shown with d1 in FIG. 4, to form a first gap for accommodating sealant 8 in a transverse direction. For example, d1 is approximately 0.2 mm. The innermost wall mentioned here is the innermost sidewall of the protrusion 10. In addition, the adhesive part 9 is arranged at a certain distance from a circumferential edge of the antenna circuit board 2 to form a second gap for accommodating the sealant 8 in the transverse direction. The transverse direction is the horizontal direction shown in FIG. 4. By providing the additional gaps, the sealant 8 can flow into the bottom of the antenna circuit board 2 from above the step of the protrusion, through the space between the circumferential edge of the antenna circuit board and the innermost wall of the protrusion 10, achieving better sealing and waterproofing effect.

In addition, the width of the step of the protrusion 10 shown in FIG. 4 is indicated by d2, which is approximately 0.8 mm. The sum of the thicknesses of the antenna circuit board 2, the cover 7, and the adhesive part 9 (optionally including the thickness of other adhesive parts) can be represented by h1, which is approximately 1.9 mm. The total thickness of the antenna circuit board 2 and the adhesive part 9 can be approximately 1.05 mm. The volume of the second accommodating space 5 of the present disclosure is relatively small, resulting in a smaller size of the rotating equipment monitoring device, and therefore a lower volume requirement for the application environment. It should be noted that the above dimensions are only for illustrative purposes and do not limit the embodiments disclosed herein.

Referring again to FIG. 3, a first opening 11 is provided on the antenna circuit board 2, and a second opening 14 at least partially aligned with the first opening 11 is provided on the partition wall 6 of the housing 1. Through the first opening 11 and the second opening 14, the explosion-proof medium mentioned above can be filled into the first accommodating space 4. In addition, a first exhaust opening 12 is also provided on the antenna circuit board 2, and a second exhaust opening 15 at least partially aligned with the first exhaust opening 12 is provided on the partition wall 6 of the housing 1. The exhaust openings are provided to exhaust the air in the first accommodating space 4 when filling the explosion-proof medium. As shown in FIG. 5, when the adhesive part 9 is double-sided adhesive tape, a third opening 16 and a third exhaust opening 17 are also provided on the adhesive part 9. The third opening 16 is at least partially aligned with the first opening 11 and the second opening 14, and the third exhaust opening 17 is at least partially aligned with the first exhaust opening 12 and the second exhaust opening 15. The quantities of the first opening 11, the second opening 14, and the third opening 16 can each be two, and of course, other quantities are also possible. In addition, the antenna circuit board 2 is also provided with a first hole 13 for an indicator light, such as LED light, a second hole aligned with the first hole 13 is provided on the partition wall 6 of the housing 1, and a third hole 18 aligned with the above two is provided on the adhesive part 9. The LED light is used to display the health status of the bearing. For example, the LED light can be configured to emit red, green, or other colored light based on the voltage applied to it to indicate different states of the bearing. Furthermore, the antenna circuit board 2 can also be provided with a solder joint 19 for welding cables.

The assembly method of the rotating equipment monitoring device described above can include the following steps: installing the sensor component 3 in the first accommodating space 4 of the housing 1; connecting the sensor assembly 3 to the antenna circuit board 2 with an antenna installed on it; installing the antenna circuit board 2 in the second accommodating space 5 of the housing 1; filling the first accommodating space 4 with the explosion-proof medium; applying the sealant 8; and installing the cover 7 on the housing 1. Specifically, connecting the sensor component 3 to the antenna circuit board 2 includes taking out the cable for the communication connection between the two from the first accommodating space 4 and soldering it onto the antenna circuit board 2. Installing the antenna circuit board 2 in the second accommodating space 5 of the housing 1 includes using the adhesive part 9 to adhere the antenna circuit board 2 to the partition wall 6 of the housing 1. Filling the first accommodating space 4 with the explosion-proof medium includes pouring the explosion-proof medium into the first accommodating space 4 through the openings on the antenna circuit board 2, the partition wall 6 of the housing 1, and the adhesive part 9. The step of applying the sealant 8 includes applying the sealant 8 to the circumferential edge of the antenna circuit board 2, and the sealant 8 flows into the first and second gaps mentioned above.

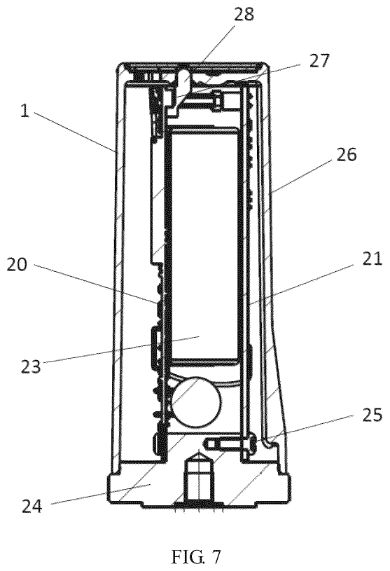

As shown in FIGS. 6 and 7, the rotating equipment monitoring device in one embodiment of the present disclosure may further comprises a first circuit board 20 and a second circuit board 21 arranged in a first accommodating space 4 and spaced apart from each other. FIG. 7 schematically shows a side view of the aforementioned circuit boards, and various electrical modules not shown in the figure are arranged on the front of the circuit boards. Specifically, the sensor assembly 3 is installed on the first circuit board 20, and a Near Field Communication (NFC) module and a Bluetooth module are arranged on the second circuit board 21. These two modules can be arranged at a certain distance from each other, and the NFC module is located above the Bluetooth module. In addition to the sensor assembly 3, the first circuit board 20 can also be provided with signal processing circuits, MCU components, etc. The above NFC modules can include NFC circuits, NFC chips, NFC antennas, etc. The Bluetooth module provided on the second circuit board 21 can only include a Bluetooth antenna, and its control components can be provided on the first circuit board 20. Specifically, the MCU component installed on the first circuit board 20 can be provided with a Bluetooth transceiver, which is connected to the Bluetooth antenna. The Bluetooth transceiver can be a Bluetooth RF interface. The first circuit board 20 and the second circuit board 21 can be connected to each other through connectors to transmit signals and provide power. The connection between the Bluetooth RF interface and the Bluetooth antenna mentioned above can also be achieved through the connectors. In addition to the electrical connection between two circuit boards, the connectors can also be used to fix the circuit boards.

The antenna arranged in the second accommodating space 5 can be an NB-IOT antenna, and other NB-IOT module assemblies that cooperate with the NB-IOT antenna are also provided on the first circuit board 20. The first circuit board 20 is also provided with the sensor assembly 3 as described above and the like. In addition, a radio frequency interface can also be provided on the first circuit board 20, with one end connected to the cable of the NB-IOT antenna and the other end directly plugged into the radio frequency interface.

The rotating equipment monitoring device also includes a power assembly 23 arranged between the first circuit board 20 and the second circuit board 21. The power assembly 23 can include a battery and a capacitor located below and connected to the battery, such as a supercapacitor. The power assembly 23 is electrically connected to the first circuit board 20, supplying power to various electronic components arranged on it, and supplying power to various electronic components or modules on the second circuit board 21 through connectors between the first circuit board 20 and the second circuit board 21.

Considering that the near-field communication module requires short-range communication, the second circuit board 21 is arranged adjacent to an inner surface of a flat sidewall 26 of the housing. As shown in FIG. 6, the housing 1 has an approximate cylindrical shape and a flat sidewall 26 which is recessed relative to the corresponding cylindrical shape. The flat sidewall 26 is matched with the second circuit board 21 to minimize the distance between the second circuit board 21 and the inner surface of the flat sidewall 26, in order to achieve good near-field signal transmission.

The first circuit board 20 and the second circuit board 21 are respectively fixed to the metal base 24 of the housing 1 through threaded fasteners 25. For example, the vibration of the bearing can be sequentially transmitted to the sensor assembly, specifically the vibration sensor, on the first circuit board 20 through the metal base 24 and threaded fasteners 25. In this vibration transmission manner, after the sensor assembly is completely surrounded by the explosion-proof medium, it can still achieve good transmission of vibration from the outside of the monitoring device to the sensor inside the monitoring device, thus achieving more sensitive vibration sensing.

An indicator light 27 and a light guide member 28 are arranged at the top of the rotating equipment monitoring device, specifically at the top of the first circuit board 20 near the partition wall 6 of the housing 1. The light emitted by the indicator light 27 is emitted towards the outside of the top of the housing 1 through the guidance of the light guide member 28. In FIG. 7, considering the installation space, the indicator light 27 is set to emit light transversely relative to the extension direction of the housing 1. Therefore, the light guide member 28 is provided to guide the light to emit from the top of the housing 1. The light guide member 28 is a commonly used light guide that utilizes reflection and refraction. The light guide member 28 is arranged to pass through the first hole 13 provided on the antenna circuit board 2 and the second hole provided on the partition wall 6 of the housing, and of course, also passes through the third hole 18 provided on the adhesive part 9. When the cover 7 is a transparent plastic cover, there is no need to provide additional holes on the cover 7 for emitting light. When the appearance of the cover 7 is consistent with that of the housing and is mainly made of opaque plastic, as shown in FIG. 6, the cover 7 is made of transparent material in the area corresponding to the indicator light 27, and has a transparent area. The light guided by the light guide member 28 is transmitted from this transparent area to the outside of the rotating equipment monitoring device.

In the method of operating the rotating equipment monitoring device provided in the present disclosure, the method is performed with the rotating equipment monitoring device as described above and includes the following steps: bringing a mobile communication device close to the flat sidewall of the housing of the rotating equipment monitoring device; activating the sensor assembly through a communication connection between a near-field communication module of the mobile communication device and the near-field communication module of the rotating equipment monitoring device; setting the sensor assembly through a communication connection between a Bluetooth module of the mobile communication device and the Bluetooth module of the rotating equipment monitoring device. The method can further comprises the following step: the sensor assembly uploads the collected data to the cloud through an antenna, the execution of which can be automatic, and the period can be set through the step of setting the sensor assembly mentioned above. It should be understood that the present disclosure does not limit the execution order of the above method steps, for example, the steps of uploading data and setting the sensor assembly can be carried out simultaneously. The mobile communication device can be a mobile phone, and the operator can perform subsequent activation and setting operations through the app on the phone. Of course, the mobile communication device can also be other devices such as tablets, as long as it has a near-field communication module and a Bluetooth module. The step of bringing the mobile communication device close to the flat sidewall 26 of the housing of the rotating equipment monitoring device allows the near-field communication module of the mobile communication device to approach the NFC module on the second circuit board, thereby achieving the communication connection between the two. The step of setting the sensor assembly through the communication connection with the Bluetooth module can also be completed by the operator through the app on the phone. Specific settings can include sensor configuration parameters such as collection mode, upload information configuration, wake-up period, and alarm threshold. For example, sensors can be set to be awakened at a certain period (such as every 8 hours) to collect vibration and/or temperature, and the results of edge processing diagnosis or processed content (depending on the specific configuration) can be uploaded to the cloud. Of course, these configuration parameters can also be realized in the cloud. In some examples, the cloud and mobile communication device can be synchronized.

In the rotating equipment monitoring device mentioned above, the antenna is not encapsulated by the explosion-proof medium and is located in a space separated from the sensor assembly and related circuits. Therefore, the rotating equipment monitoring device has high transmission efficiency and can meet the requirements of Nc sealing explosion-proof level. In addition, the explosion-proof medium is used to encapsulate the sensor assembly such that the rotating equipment monitoring device has high monitoring sensitivity and good temperature resistance performance. The use of the sealant and gaps mentioned above enables the rotating equipment monitoring device to have improved waterproof performance and thus high reliability.

Specifically, the rotating equipment monitoring device of the present disclosure can achieve an average transmission efficiency as high as more than 30%, which can meet the requirements of sufficiently long transmission coverage and reduce communication power consumption, thereby extending the service life of the sensor. Based on the above transmission efficiency, the rotating equipment monitoring device of the present disclosure can use narrowband wireless communication technology, such as Narrow Band Internet of Things (NB-IOT), to achieve long-distance wireless transmission, thereby achieving the function of long-distance communication and uploading data to the cloud, without relying on a gateway. Specifically, through the wide-area wireless communication technology such as NB-IOT, diagnostic data can be uploaded to the cloud, including alarm data of rotating equipment, spectrum raw data (for manual or intelligent diagnosis) and so on.

Furthermore, the rotating equipment monitoring device with a 2-zone explosion-proof rating of the present disclosure can be used in areas with gas explosion hazards and areas with dust explosion hazards, which cannot be achieved by existing rotating equipment monitoring devices that are based on NB-IOT or other wide-area network wireless communication. The rotating equipment monitoring device of the present disclosure has passed Ex nC IIC T4 Gc certification in areas with gas explosion hazards in accordance with national standards GB 3836.1-2021 and GB 3836.8-2021, and passed Ex tc IIIC T135° C. Dc certification in areas with dust explosion hazards in accordance with national standards GB 3836.1-2021 and GB 3836.8-2021. The above certifications cannot be achieved by existing rotating equipment monitoring devices that are based on wide area network wireless communication such as NB-IOT and have passed 2-zone explosion-proof certification.

In addition, the method for operating the rotating equipment monitoring device of the present disclosure utilizes a combination of NFC and Bluetooth communication technologies with narrowband wireless communication technology, which not only facilitates the activation of the rotating equipment monitoring device, but also allows for flexible setting of various parameters of the rotating equipment monitoring device.

The disclosed technical features mentioned above are not limited to combinations with other features that have already been disclosed. Those skilled in the art may also combine other technical features according to the object of the disclosure, in order to achieve the object of the present disclosure.

What is claimed is:

1. A rotating equipment monitoring device comprising:
a housing comprising a first accommodating space and a second accommodating space, wherein the second accommodating space is located at an end of the housing and separated from the first accommodating space by a partition wall of the housing;
a sensor assembly arranged in the first accommodating space;
an antenna circuit board with an antenna installed thereon, wherein the antenna is configured to communicate with the sensor assembly and is arranged in the second accommodating space; and
a cover sealing the antenna circuit board in the second accommodating space,
wherein the first accommodating space is filled with an explosion-proof medium that completely surrounds the sensor assembly.

2. The rotating equipment monitoring device according to claim 1, wherein the rotating equipment monitoring device further comprises an adhesive part, which adheres the antenna circuit board to the partition wall of the housing.

3. The rotating equipment monitoring device according to claim 2, wherein the housing comprises a stepped protrusion at an inner wall at its end, and the protrusion extends along the circumference of the inner wall.

4. The rotating equipment monitoring device according to claim 3, wherein the rotating equipment monitoring device further comprises a sealant, which is filled between the cover and the protrusion along the circumference of the antenna circuit board.

5. The rotating equipment monitoring device according to claim 4, wherein the antenna circuit board is arranged at a certain distance from an innermost wall of the protrusion to form a first gap for accommodating the sealant in a transverse direction.

6. The rotating equipment monitoring device according to claim 4, wherein the adhesive part is arranged at a certain distance from a circumferential edge of the antenna circuit board to form a second gap for accommodating the sealant in a transverse direction.

7. The rotating equipment monitoring device according to claim 1, wherein a first opening is provided on the antenna circuit board, and a second opening at least partially aligned with the first opening is provided on the partition wall of the housing, wherein the explosion-proof medium is filled into the first accommodating space through the first opening and the second opening.

8. The rotating equipment monitoring device according to claim 7, wherein a first exhaust opening is also provided on the antenna circuit board, and a second exhaust opening at least partially aligned with the first exhaust opening is provided on the partition wall of the housing.

9. The rotating equipment monitoring device according to claim 1, wherein the rotating equipment monitoring device further comprises a first circuit board and a second circuit board arranged in the first accommodating space and spaced apart from each other, wherein the sensor assembly is arranged on the first circuit board, and a near-field communication module and a Bluetooth module are arranged on the second circuit board.

10. The rotating equipment monitoring device according to claim 9, wherein the antenna is an NB-IOT antenna, and other NB-IOT module assemblies that cooperate with the NB-IOT antenna and a radio frequency interface for connecting with the antenna are also provided on the first circuit board.

11. The rotating equipment monitoring device according to claim 9, wherein the rotating equipment monitoring device further comprises a power assembly arranged between the first circuit board and the second circuit board.

12. The rotating equipment monitoring device according to claim 9, wherein the second circuit board is arranged adjacent to an inner surface of a flat sidewall of the housing.

13. The rotating equipment monitoring device according to claim 9, wherein the housing comprises a metal base, and the first circuit board and the second circuit board are respectively fixed to the metal base through threaded fasteners.

14. The rotating equipment monitoring device according to claim 9, wherein an indicator light and a light guide member are arranged at the top of the first circuit board near the partition wall of the housing, and the light emitted by the indicator light is emitted towards the outside of the top of the housing through the guidance of the light guide member.

15. The rotating equipment monitoring device according to claim 14, wherein a first hole is provided on the antenna circuit board, a second hole aligned with the first hole is provided on the partition wall of the housing, and the light guide member passes through the first hole and the second hole.

16. The rotating equipment monitoring device according to claim 6, wherein a first opening is provided on the antenna circuit board, and a second opening at least partially aligned with the first opening is provided on the partition wall of the housing, wherein the explosion-proof medium is filled into the first accommodating space through the first opening and the second opening.

17. The rotating equipment monitoring device according to claim 16, wherein a first exhaust opening is also provided on the antenna circuit board, and a second exhaust opening at least partially aligned with the first exhaust opening is provided on the partition wall of the housing.

18. The rotating equipment monitoring device according to claim 6, wherein the rotating equipment monitoring device further comprises a first circuit board and a second circuit board arranged in the first accommodating space and spaced apart from each other, wherein the sensor assembly is arranged on the first circuit board, and a near-field communication module and a Bluetooth module are arranged on the second circuit board.
